(19) United States
(12) Patent Application Publication
(10) Pub. No.: US 2005/0049960 A1
(43) Pub. Date: Mar. 3, 2005

(54) Methods and apparatus for tracking online auction visitors

(76) Inventor: Wayne B. Yeager, Lexington, KY (US)

Correspondence Address: KING & SCHICKLI, PLLC, 247 NORTH BROADWAY, LEXINGTON, KY, 40507, US

(21) Appl. No.: 10/914,330

(22) Filed: Aug. 9, 2004

Related U.S. Application Data
(60) Provisional application No. 60/497,719, filed on Aug. 25, 2003.

(51) Int. Cl. G06F 17/60

(52) U.S. Cl. 705/37

(57) ABSTRACT

In a computer system, methods, data structures, computing environments and computer readable media are disclosed for monitoring, tracking and/or observing visitors of an online auction, including the means by which visitors arrive at same. In one embodiment, the present invention is comprised of computer programming code embedded in an online auction page, a dynamic tracking computer program that resides on a web server that receives and logs the data transmitted by said embedded code, and a computer program that resides on a web server that interprets and translates the logged data into a graphical user interface.

This application claims the benefit of U.S. Provisional Application No. 60/497,719, filed on Aug. 25, 2003.

### FIELD OF THE INVENTION

The present invention relates to obtaining, recording, arranging and presenting information regarding visitors of an internet or intranet website. More specifically, it relates to online auction websites and to a contemporary or real-time tracking system for monitoring, tracking or otherwise observing the visitors to online auctions. Even more particularly, the invention contemplates data structures, arrangements of stored information and methods and computer-readable medium that facilitate the monitoring, tracking or observing of visitors.

### BACKGROUND OF THE INVENTION

Heretofore, monitoring or tracking visitors of an internet or intranet website, especially an auction page, has been limited to simple counters and other graphical representations indicating the number of viewers a particular auction has received. With reference to FIG. 5, some of the more popular counters embody “hit counters,” generally 60, 61, 62, having odometer-style architecture showing ones 63, tens 64, hundreds 65, thousands 66, ten-thousands 67, etc., columns that become incremented each time a new visitor visits or views the website incorporating the hit counter. As shown, each of the hit counters 60, 61, 62 has recorded three visitors.

Problematically, these hit counters do not provide website providers or, in the instance of an online auction website, online auction sellers with relevant information or data about the visitors themselves. For example, conventional counters do not provide online auction sellers with any data regarding the means or path by which the visitor arrived at the seller's auction page.

While hit counters may be suitable for occasional sellers, they are not suitable for professional or advanced sellers on online auction websites who wish to have, and can benefit from, visitor-specific data.

In these respects, the system for tracking online auction visitors according to the present invention substantially departs from the conventional concepts and methods of the prior art, and in so doing, provides a system for website providers, including online auction sellers, to monitor and track individual visitors as well as the means by which the visitor arrived at the online auction page.

### SUMMARY OF THE INVENTION

The above-mentioned and other problems become solved by applying the principles and teachings associated with the hereinafter described methods and apparatus for tracking visitors of online auctions.

Online auctions have become a major component of ecommerce, with billions of dollars in transactions being conducted each quarter. While most online auction users are only occasional sellers, a significant portion of online auction users are advanced, professional and even full-time sellers who depend on online auctions for much—if not all—of their sales revenue.

Success in business is often dependent on the availability of data for decision-making purposes, and the availability of online auction customer data has been limited in prior art tracking devices. Indeed, prior art tracking devices merely provide the number of visitors to a particular online auction, and no information is provided about the visitor himself, or the means by which the visitor arrived at the online auction.

In view of the foregoing disadvantages inherent in the known methods of tracking auction visitors now present in the prior art, the present invention provides a method by which online auction sellers can monitor the browsing, searching and sorting patterns of the visitors to their online auction pages, as well as track data related to each individual visitor.

The general purpose of the present invention, which will be described subsequently in greater detail, is to provide a new method of tracking online auction visitors, with many novel features that result in a tool for online auction sellers that is not anticipated, rendered obvious, suggested or even implied by any of the prior art counters, either alone or in any combination thereof.

To attain this, the present invention generally comprises computer programming code which is emplaced or embedded by the online auction seller, or by the auction provider or a third party on his behalf, into the code which comprises the online auction seller's auction description. Each time an online auction user visits an online auction page, the embedded code retrieves information related to the referring document and the user, and delivers this information or data to a web server. Additional computer programming code on the server deciphers this data and renders it in a format useful to the online auction seller.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a system for observing, recording, tracking, observing and/or monitoring online auction visitors that will overcome the shortcomings of the prior art methods.

An object of the present invention is to provide information or data to online auction sellers sufficient to improve their marketing decisions as they relate to online auctions.

Another object of the present invention is to enable online auction sellers to determine the IP address of the visitors to their online auctions.

Another object is to enable online auction sellers to determine if single visitors have viewed their online auctions multiple times.

Another object is to enable online auction sellers to determine the geographical location of the visitors to their online auctions.

Another object is to enable online auction sellers to know the date and time that visitors visited their online auctions.

Another object is to enable online auction sellers to know if their reserve price was met or not yet met (NYM) at the time a specific visitor visited their online auction.

Another object is to enable online auction sellers to determine the category or categories in which a visitor to their online auction was browsing and/or searching prior to arriving at the seller's auction page.

Another object is to enable online auction sellers to determine which search criteria, term(s) or phrase(s) a visitor used to find the seller's auction page.

Another object is to enable online auction sellers to determine if the search term(s) or phrase(s) a visitor used to find the seller's auction page were searched for in the auction titles only, or in both the titles and descriptions.

Another object is to enable online auction sellers to determine if the visitor set specific limits while conducting a search, such as regional limitations, upper and lower price limits, search term exclusions, limits on payment methods, limits on shipping methods or availability, limits on physical location of item being sold, limits on acceptance of escrow, or any other limits provided for in the search schemas of online auction sites.

Another object is to enable online auction sellers to know which type of sorting their online auction visitors used when viewing results, such as chronological sorting (auctions ending first or last), sorting by price (highest-to-lowest or lowest-to-highest), or any other sorting techniques provided for in the sort schemas of online auction sites.

Another object is to enable online auction sellers to know any or all of the aforementioned information or data as it relates to visitors who placed bids on their online auctions.

Another object is to enable online auction sellers to know any or all of the aforementioned information or data in a plurality of auctions.

Another object is to enable online auction sellers to know any or all of the aforementioned information or data in real-time.

In one embodiment, the present invention contemplates a method for communicating information about a visitor visiting an online auction of a seller in accordance with the obtainment and emplacement of a code in an auction description of the online auction. Then, upon the visitor visiting the online auction, the information about the visitor is provided to the seller. In some embodiments, the code exists on the same website as the venue or website of the online auction. In other embodiments, the code exists on a website different from the website of the online auction and may exist on the same website that displays the information to the seller. In specific embodiments, the code is a scripting language code written in JAVASCRIPT or HTML language.

In other aspects, the invention contemplates an online auction website making an inquiry of whether the seller desires to receive information about visitors of their particular auction and, upon an affirmative response from the sellers, making such information available. In this manner, the online auction website or venue can directly provide the service to the seller and do so in a manner essentially invisible thereto.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

Various other objects, features and attendant advantages of the present invention will become fully appreciated as the same becomes better understood when considered in conjunction with the accompanying drawings, wherein:

FIGS. 1a and 1b illustrate a generic online auction listings page in accordance with the present invention, and its typical features, as well as the impact on a web browser's address bar;

FIG. 2 illustrates a generic item-specific online auction page in accordance with the present invention and its typical features, including an auction description;

FIG. 3 is a diagram in accordance with the present invention illustrating one method employed by the present invention to extract relevant information of a visitor viewing an auction description and translate same to a Graphical User Interface (GUI) for use by an online auction seller;

FIG. 4 illustrates a generic Graphical User Interface (GUI) in accordance with the present invention for the purpose of presenting the raw auction data to the online auction seller in a useful format;

FIG. 5 illustrates three examples of prior art tracking devices;

FIG. 6 is a flow diagram in accordance with the present invention of another method of extracting relevant information of a visitor viewing an auction description and presenting same to an end user desirous of such information;

FIG. 7 is an exemplary system in accordance with the present invention providing a suitable operating environment for carrying out the extraction and displaying of relevant information of a visitor viewing an auction description on an online auction website; and

FIG. 8 is a diagram in accordance with the present invention representative of one embodiment of an online auction website or venue inquiry as to a seller's desire to receive information regarding visitor's of their particular online auction.

### DETAILED DESCRIPTION OF THE PREFERRED EMBODIMENTS

In the following detailed description of the preferred embodiments, reference is made to the accompanying drawings that form a part hereof, and in which is shown by way of illustration, specific embodiments in which the inventions may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and their equivalents. Turning now to the drawings, the attached figures broadly serve to illustrate methods and apparatus for tracking, monitoring or otherwise observing visitors of online auctions. More specifically, they serve to illustrate preferred methods of recording information or data from online auction visitors which comprises computer software code for gathering the data, a method of storing the retrieved data on a computer server connected to the world wide web, and a method of parsing and deciphering the data in such a way that it can be rendered in a useful format for the online auction seller.

When a world wide web user 35 or visitor visits an online auction, the web browser software on the user's computer 34 requests data packets from the web server of the individual or organization providing the auction venue 31. These data packets 32 travel to the user's computer, and are rendered into readable form by the user's web browser.

A portion of the data that is sent to the online auction visitor is predetermined by the online auction seller, such as the title of the auction 21, the description of the auction 25, and photographs or illustrations of the object for sale 24.

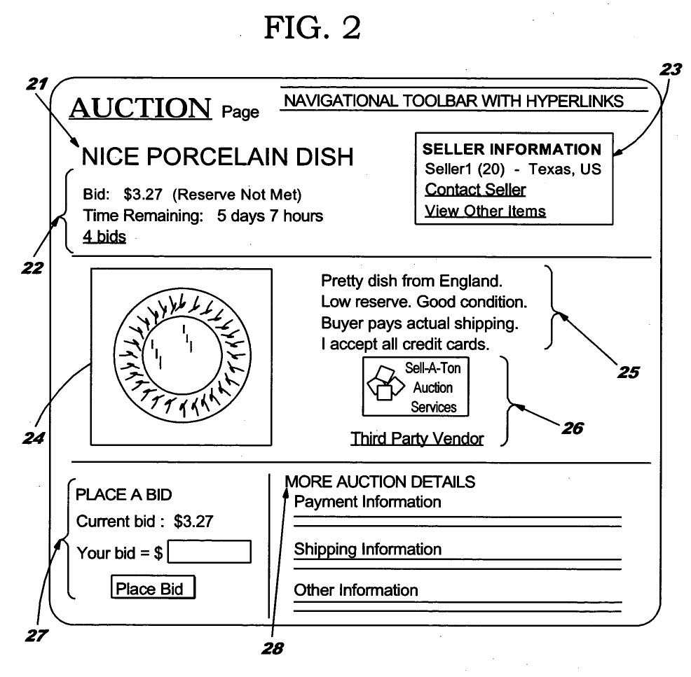

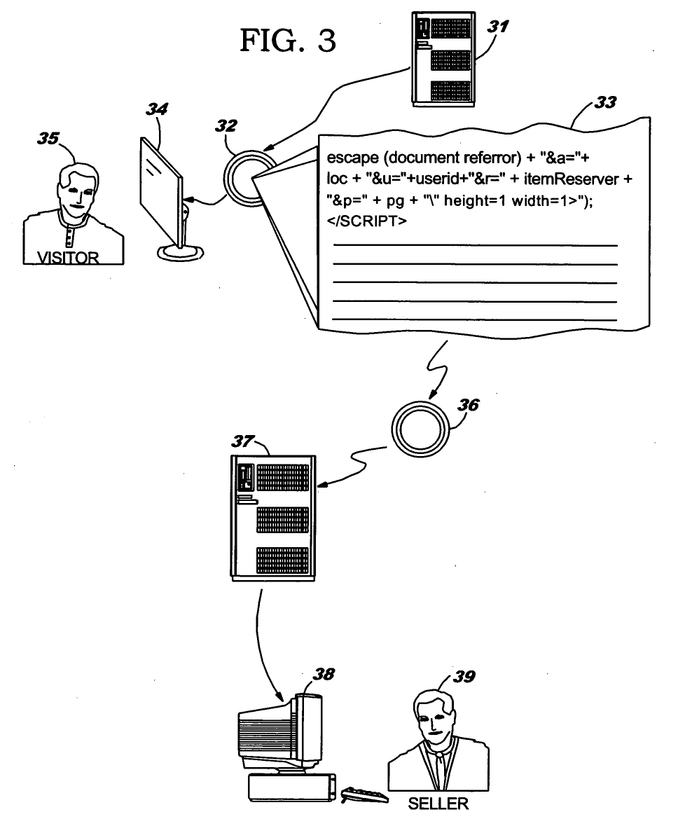

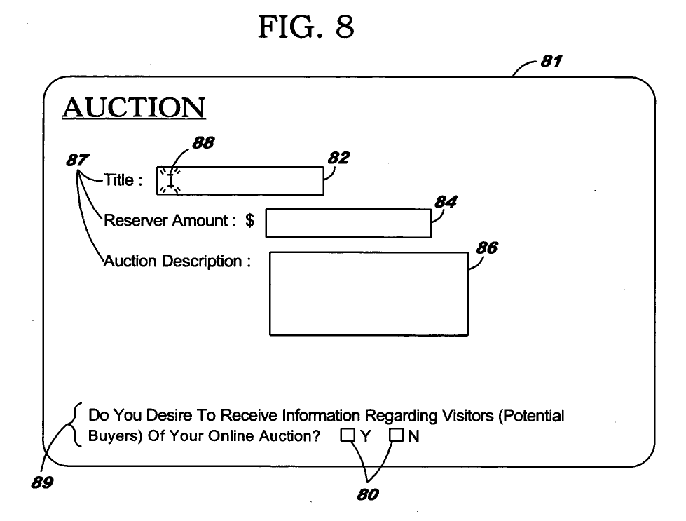

To clarify, the data itself usually resides on the web server of the individual or organization providing the auction venue, but the contents of those data is determined by the auction seller. For example, with reference to FIG. 8, auction venues typically cause a page 81 to be rendered on a display of a seller's computer 38 (FIG. 3) for soliciting auction-specific information. In general, the page has blocks 82, 84, 86 that require completion by the seller before an online auction of the object for sale 24 (FIG. 2) can begin. In its simplest form, the seller places their cursor 88 in the blocks and types out necessary content as called for by the descriptor language 87 adjacent thereto. In one representative embodiment, the auction venue corresponds to the eBay Corporation and www.EBAY.com represents the home page URL accessed by sellers to eventually cause display of a page comparable to page 81.

In addition, the online auction venue calculates and/or provides additional data for the benefit of the visitor, such as the current price of the item, time remaining in the auction, number of bids the item has received 22, information about the seller 23, a means for bidding on the item 27, and any additional relevant auction data 28.

Furthermore, the online auction seller and/or the online auction venue can add additional data to the online auction page, such as advertisements, internal and/or external links, acknowledgement of sponsors and/or third party vendors 26, etc.

Since the auction venue, and, in most cases, the online auction seller, can place additional data on auction pages, the present invention relates to adding appropriate computer programming code 33 to the auction description 86 (FIG. 8) such that it records and transmits the visitor's information or “environment variables” and/or other relevant information 36 to a secondary or external web server 37.

The online auction visitor's environment variables are immediately accessible to various scripting languages, including JAVASCRIPT and VBScript. The visitor's environment variables include, but are not limited to: his or her IP Address; URL of last page visited (commonly called “referring document”); browser type and version; which type of images are accepted; if defined, his or her default language; and the like.

Consequently, if the environment variables are accessed and then transmitted to an external server 37 by computer programming code 33 placed on an online auction page (FIG. 2), via the initial entry of the auction description 86 (FIG. 8), the IP address of the visitor, the referring document, and any other information or environment variable of the online auction visitor can be permanently stored. Of course, any information or environment variable permanently stored can ultimately become rendered later on a display or other of a seller's computer 38.

One technique for accessing the visitor's environment variables is illustrated below using JAVASCRIPT language, although any computer scripting language will suffice.

If added to a page containing HTML code (the computer markup language used to generate webpages), the following code will assign the URL of the last page the visitor visited to the variable “referringpage”:
<script language=“JavaScript”>
var referringpage=escape(document.referrer);
</script>

At this point, skilled artisans will appreciate that auction venues, such as the eBay Corporation, often present their to-be-completed auction descriptions to sellers on pages of their website in a format favoring HTML. In one embodiment, as of the time of filing this application, the eBay Corporation specifically instructs sellers to “Enter either plain text or HTML” in its auction “Description” block. They even provide an “HTML tips” link to assist sellers in this regard. Accordingly, the herein described scripting language functions superbly with such HTML based auction description formats. To access the Description block, would-be sellers navigate within the www.EBAY.com website by advancing from the Home Page to the “Sell” link and the “1. Category” and the “2. Title & Description” pages.

Scripting language can also retrieve information about the page a visitor is currently viewing, such as the title of the page, the variables defined in other scripting subroutines, persistent cookies (with appropriate permission), the URL of the current page, etc.

If added to a page containing HTML code, the following code will assign the URL of the current page to the variable “currentpage” and will assign the title of the page to the variable “pagetitle”:
<script language=“JavaScript”>
var currentpage=location.href;
var pagetitle=document.title;
</script>

Data that is accessible to a scripting language can be sent to an external or secondary server 37 for storage. That is accomplished by using Common Gateway Interface (CGI) programming and the “GET” request method.

In the present invention, when the online auction visitor loads an auction page in his browser, the code 33 residing on the auction page, especially within the auction description 25 initially entered by the seller in block 86 of page 81, executes inside the visitor's browser and, using a scripting language, assigns data to variables that may be of interest to the online auction seller.

For example, the scripting code in the preferred embodiment uses variables to hold the values of the URL of the referring document, the URL of the current document, the title of the current page, and the reserve price status of the current auction.

Once the variables are assigned values, the scripting code delivers this data to an external (or internal) server using CGI's ability to transmit values to an external script using the “GET” request method. In JAVASCRIPT language, this is accomplished thusly:
<script language=“JavaScript”>
var referringpage=escape(document.referrer);
var maindomain=“http://www.domain.com/”;
var currentpage=location.href;
var pagetitle=document.title;
document.write(“<img src=\“”+maindomain+”cgi-bin/track.cgi?1=“+referringpage+”&a=“+currentpage+”&r=“+itemReserve+”&p=“+pagetitle+”\“height=X width=Y>”);
</script>; wherein X and Y correspond to a numeric value indicative of a desired size of pixel in the form X x Y, such as 1×1.

When placed in an HTML page, this script will send the previously mentioned stored data to http://www.domain.com/cgi-bin/track.cgi. (Note the use of the HTML tag <img> to accomplish the data transmission. An image is not actually loaded, nor is one intended to be; it's simply a method of getting the variable data to the track.cgi script.)

The primary reason the referring document is of chief concern is that it contains not only the previous page the visitor visited, but embedded within that URL is detailed information about the manner in which the visitor found the seller's auction.

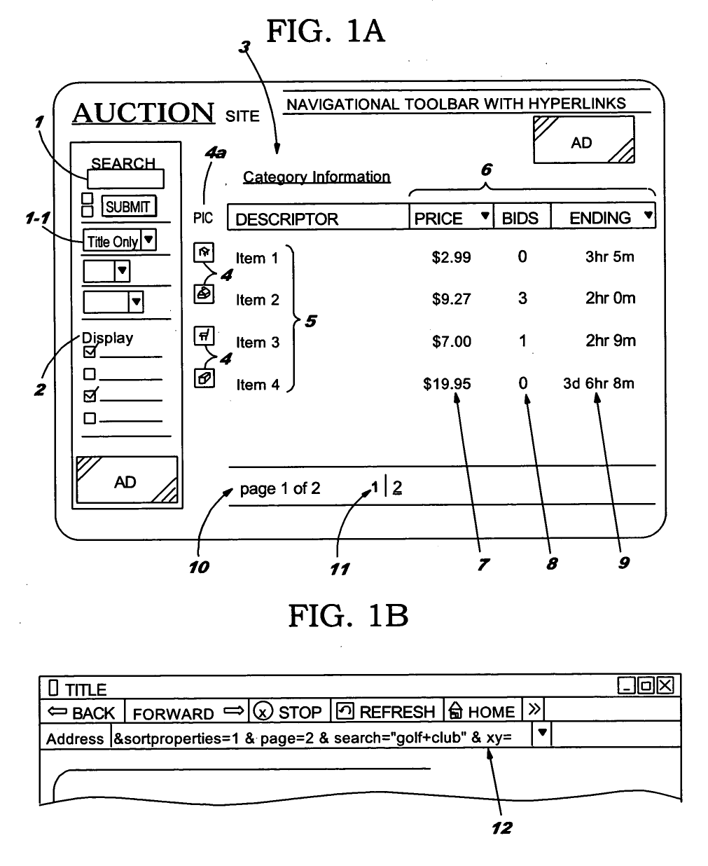

FIG. 1a illustrates the typical features of an online auction listings page. Generally, there is a mechanism, such as a search field 1 and category selector 1-1, for searching the auction venue's item listings, and for determining whether the search criteria, term(s) or phrase(s), should be sought in just the auction titles, or in both the titles and descriptions. Additionally, there is generally a mechanism 2 for determining the manner in which the listings should be displayed, such as by price or by auction ending date; information about the category 3 in which the visitor is browsing or searching, such as antiques, cars, sports, to name a few; photographs or illustrations 4 under the label “pic” 4a of the item for sale; a column 5 containing the titles of the auctions available that match a visitor's search and/or sort criteria; a plurality of mechanisms 6 for sorting the auction listings, such as sorting by chronology, by price, by number of bids, by methods of payment, by methods of selling, and by others provided for in the sorting schema of the online auction venue.

Regardless of how the listings are searched, browsed or sorted, the online auction listings page also allows visitors to view the current price 7 of an item, the number of bids 8 the item has received, how much time is left 9 before the auction ends, the page number of the listings 10 the visitor is currently viewing, and hyperlinks or form buttons 11 that allow the visitor to view additional pages (if any) of listings.

When the visitor interacts with an online auction listings page, that interaction can be determined by examining the URL of the listings page 12 (FIG. 1b). For example, a search conducted on the www.EBAY.com website for a “CAMARO” in the keywords field and having a “Price Range” between $4000 and $8000 revealed the following URL of the online auction listings page:
http://search.ebay.com/search/search.dll?cgiurl=http%3A%2F%2Fcgi.ebay.com%2Fws%2F&MfclSAPICommand=GetResult&ht=1&from=R7&ebaytag1=ebayreg&query=camaro&query2=camaro&search option=1&exclude=&cateory0=&minPrice=4000&maxPrice=8000&ebaytag1code=0&st=&SortProperty=MetaEndSort.

Advantageously, by understanding how to decipher the contents of this URL, it is possible to reconstruct the visitor's search criteria and know exactly what they searched for, which categories the visitor browsed in and how the visitor sorted the resulting listings. Once learned, a professional or regular seller on the auction venue can more readily understand the relevant market of would-be buyers or visitors. As a simple illustration, and by continuing with the previous “CAMARO” search example, if a seller regularly sells automobiles and learns or recognizes that visitors most often search for automobiles by specific automobile type, e.g. “CAMARO,” the seller knows that to have the greatest exposure for their future online auctions and to target a majority of would-be car buyers, they need to have the automobile type included in their listing.

Moreover, this knowledge of a visitor's search criteria in combination with knowledge that can be obtained regarding the previously described visitor's environment variables, a seller of an auction can now know, among other things: the visitor's IP address; their geographic location; the manner in which they found the online auction; the date and time in which they found the online auction; the search criteria used; whether or not the visitor searched by the “Titles” only or the “Titles and Descriptions;” how the visitor sorted the search; etc. Again, knowledge of this type can directly translate into better marketing to would-be buyers or visitors of online auctions.

Prior to the present invention, the only way to access this data was to stand over the shoulder of the online auction visitor and view the address line of the visitor's web browser. But since this URL becomes the referring document whenever a visitor views the seller's online auction page, and since in the present invention, this data is transmitted to an external server, it is now accessible to the online auction seller.

Whereas step one of the present invention, in one embodiment, is a method of recording and transmitting the contents of the online auction visitor's environment variables (and other pertinent data) to an external or secondary server, step two is the retrieval and storage of that information for later use.

Step two comprises a server 37 connected to the world wide web, with dynamic scripting capabilities such as CGI, perl, asp (or any other scripting language that allows external variables to dynamically determine how a given script is executed).

In the preferred embodiment, perl-based CGI is used, although any scripting language will suffice.

When the scripting code 33 is rendered inside the online auction visitor's web browser, it sends data 36 to a script (on web server 37) called, in this embodiment, track.cgi, which parses the data and saves it to a log file (on web server 37), along with the date and time and the visitor's IP address. As before, cgi stands for “common gateway interface” and it generally defines the rules of communication between information servers, such as between gateway programs and HTTP servers of the world wide web.

In one preferred embodiment, the IP address of the visitor is determined by track.cgi at the moment track.cgi is loaded. However, the visitor's IP address could be determined by the script located on the seller's auction page, and then transmitted to track.cgi as another variable.

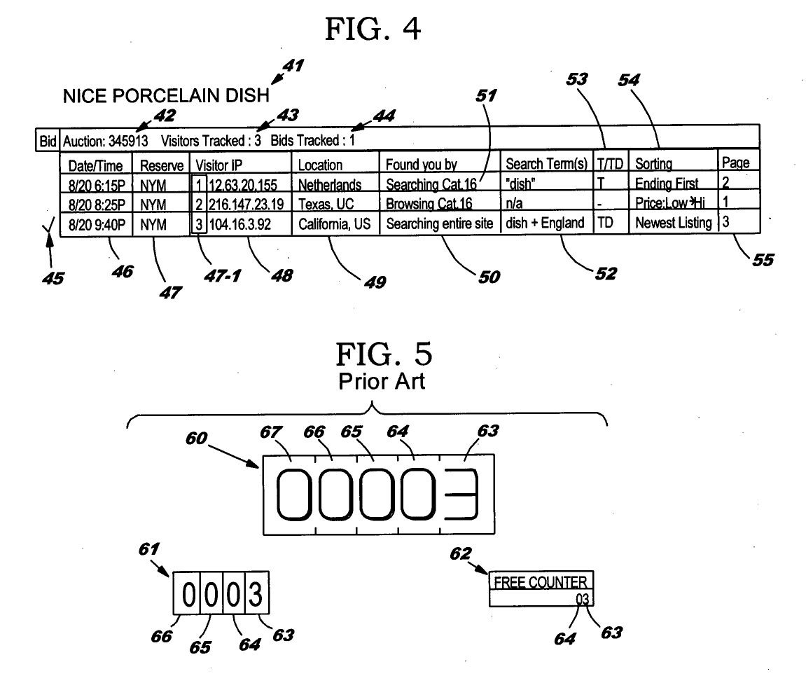

At this stage, the data is simply parsed and logged. In the final step, step three of the preceding embodiment, an additional script on server 37 will render the raw data into a more useful format for the online auction seller 39. As will be more fully described below, one useful format corresponds to the arrangement of information in FIG. 4.

Thereafter, the present invention comprises a computer 38 connected to the world wide web, which has a web browser installed and is capable of rendering HTML generated by CGI or other scripting language.

The online auction seller 39 accesses server 37 through his computer 38, and loads a cgi script called, simply for illustrative purposes, stats.cgi.

Stats.cgi opens the logfile associated with the online auction seller who accesses the script. The online auction seller can then choose which auction, if he is currently managing a plurality of auctions, to view the data for. In one preferred embodiment, the online auction seller is shown a page that is dynamically generated by stats.cgi, listing all the online auctions belonging to the current seller that are live and ongoing.

In another preferred embodiment, once a specific auction is chosen, stats.cgi compiles the data associated with that particular auction, and deciphers the contents of that data according to the instructions within stats.cgi.

As an example, stats.cgi may contain instructions (provided by the programming team) that the online auction venue uses “sortproperties=1” in the URL line 12 of the online auction listings page (FIG. 1b.) when the auction listings are sorted by the visitor from highest price to lowest price. As another example, stats.cgi may contain instructions that whenever “pictures=no” appears in the URL line of the online auction listings page, that this phrase corresponds to the visitor having selected “Hide Pictures” in the Display options 2 of the online auction listings page.

Once these “codes” have been determined, it's simply a matter of stats.cgi checking for the existence of these codes and rendering the data appropriately. Skilled artisans will further understand that the inventor of the present invention has reverse engineered and learned the meaning of all eBay Corporation codes, for example, and the foregoing described scripting language in combination with the cgi instructions, etc., provides the mechanism for presenting the visitor information to the seller.

FIG. 4 illustrates one embodiment of how this data can be rendered for the benefit of the online auction seller.

For identification purposes, the page generated by stats.cgi contains the title 41 of the auction, and for convenience purposes, the auction number 42 is provided as a hyperlink directly to the auction.

At a glance, the online auction seller can see how many visitors 43 a particular auction has received, how many bids 44 have been placed for the item, the date and time 46 each visitor arrived at the auction page, whether the reserve price had already been met when the visitor arrived 47 (NYM representing an indication that the reserve is “not yet met,” for example), the sequential visitor number 47-1 and the IP address 48 of each visitor, the physical location of the visitor 49, the manner in which the auction was found 50, a hyperlink 51 to a specific category (for seller verification), the search criteria, term(s) or phrase(s) 52 used by the visitor to find the auction, whether the search term(s) or phrase(s) were searched for in titles only or titles and descriptions 53, the manner in which the auction listings and/or search results were sorted 54, and the page number 55 of those listings on which the auction was found.

Furthermore, a checkmark 45 or other indicator informs the online auction seller which (if any) visitors placed a bid on the item being auctioned.

Although most of this data is contained within the logfile for each auction, some of it is dynamically generated (such as the sequential visitor number), some is generated by stats.cgi based on clues within the referring document (such as whether or not a particular visitor placed a bid), and some is generated through external sources (such as vendors that can dynamically associate IP addresses to geographic locations).

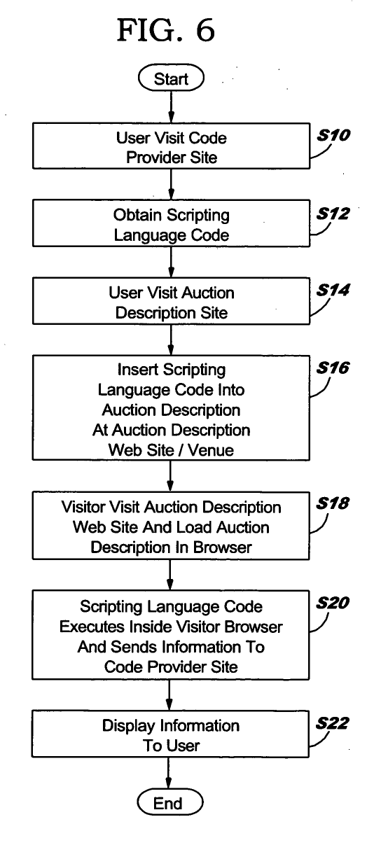

With reference to FIG. 6, one embodiment of the invention contemplates that, at step S10, users or sellers of the auction venue will first visit a code provider website to obtain, step S12, the necessary scripting language code previously described. At step S14, the user or seller will then visit the website of the auction venue, and more particularly the page therein that displays to the seller the “auction description,” and emplace or insert such code into the auction description. As previously described, the auction description may embody a block 86 (FIG. 8) that is displayed by the auction venue at their website that requires entry by the seller to cause any one auction to take place. In a preferred embodiment, the code obtained by the seller is “cut” from the code provider site and “pasted” into the block 86 of the auction description through well known cut/paste editing operations. In other embodiments, the code is copied and pasted or merely copied and transcribed in place.

At step S18, a visitor of the online auction venue website searches for a given item and, through various navigation of the previously described online auction listings page (FIG. 1a), arrives at a particular auction of the seller as indicated by the Auction page (FIG. 2) of the seller. In so doing, the auction description 25 of the seller, which contains the scripting language code previously inserted or emplaced by the seller, causes execution inside the visitor's browser S20. This causes sending of the information back to the code provider site, such as described in reference to the elements of FIG. 3, and the ultimate display of information to the user or seller, S22. In a preferred embodiment, the displayed information embodies that shown in FIG. 4.

Although the foregoing was described such that sellers went to a code provider website different from the website of the auction venue, skilled artisans will understand that auction venues may make such codes directly available within their own website to cause the visiting of a single website and ultimately less inconvenience of a seller. They may additionally make such code obtaining and code emplacing essentially invisible to the seller, through appropriately written executable software, by merely inquiring whether the seller desires to receive such visitor information and, upon a positive indication from the seller, providing the information to the seller as part of the auction venue services. One embodiment of inquiring follows that shown in FIG. 8 in the form of question 89. Positive indication from the seller becomes understood upon the seller's ticking of one of the yes/no blocks 80. In still another embodiment, as described more fully below, the code may reside on a computer readable medium that a user inserts into their computer that causes execution of the foregoing steps.

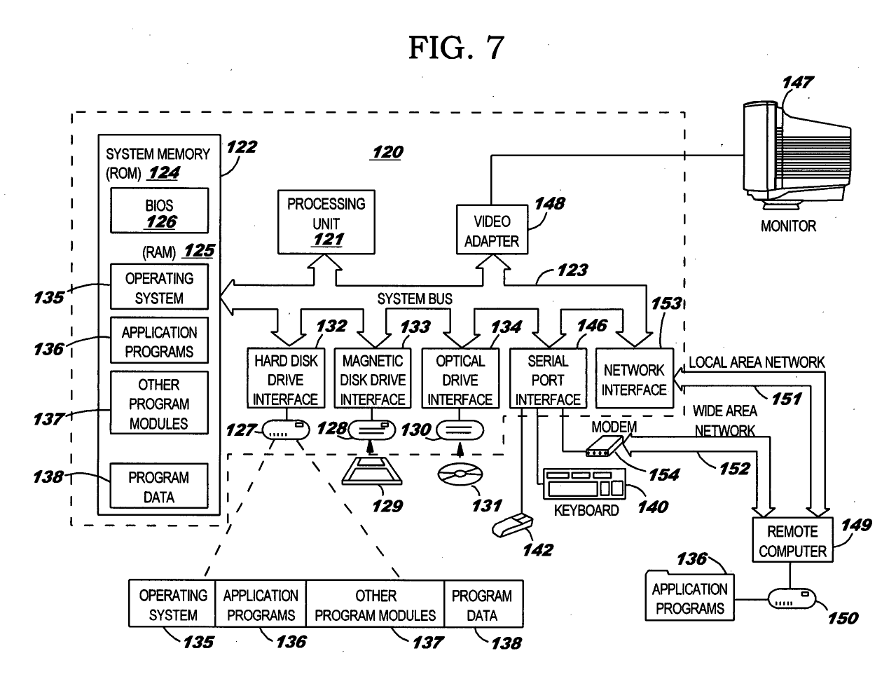

Appreciating that both end users, e.g., sellers and visitors, of the present invention will likely accomplish some aspect of the methods in a computing system environment, FIG. 7 and the following discussion are intended to provide a brief, general description of a suitable computing environment in which either the structure or processing of embodiments may be implemented. Since the following may be computer implemented, particular embodiments may range from computer executable instructions as part of computer readable media to hardware used in any or all of the following depicted structures. Implementation may additionally be combinations of hardware and computer executable instructions.

When described in the context of computer readable media having computer executable instructions stored thereon, it is denoted that the instructions include program modules, routines, programs, objects, components, data structures, etc. that perform particular tasks or implement particular abstract data types upon or within various structures of the computing environment. Executable instructions exemplarily comprise instructions and data which cause a general purpose computer, special purpose computer, or special purpose processing device to perform a certain function or group of functions.

The computer readable media can be any available media which can be accessed by a general purpose or special purpose computer. By way of example, and not limitation, such computer readable media can comprise RAM, ROM, EEPROM, CD-ROM or other optical disk storage devices, magnetic disk storage devices or any other medium which can be used to store the desired executable instructions or data fields and which can be assessed by a general purpose or special purpose computer. Combinations of the above should also be included within the scope of the computer readable media. For brevity, computer readable media having computer executable instructions may be referred to as “software” or “computer software”.

With reference to FIG. 7, an exemplary system for implementing the invention includes a general purpose computing device in the form of a conventional computer 120. The computer 120 includes a processing unit 121, a system memory 122, and a system bus 123 that couples various system components including the system memory to the processing unit 121. The system bus 123 may be any of the several types of bus structures including a memory bus or memory controller, a peripheral bus, and a local bus using any of a variety of bus architectures. The system memory includes read only memory (ROM) 124 and a random access memory (RAM) 125. A basic input/output system (BIOS) 126, containing the basic routines that help to transfer information between elements within the computer 120, such as during start-up, may be stored in ROM 124. The computer 120 may also include a magnetic hard disk drive, not shown, a magnetic disk drive 128 for reading from and writing to removable magnetic disk 129, and an optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide nonvolatile storage of computer readable instructions, data structures, program modules and other data for the computer 120.

Although the exemplary environment described herein employs a hard disk, a removable magnetic disk 129 and a removable optical disk 131, it should be appreciated by those skilled in the art of other types of computer readable media which can store data accessible by a computer include magnetic cassettes, flash memory cards, digital video disks, removable disks, Bernoulli cartridges, random access memories (RAMs), read only memories (ROM), and the like.

Other storage devices are also contemplated as available to the exemplary computing system. Such storage devices may comprise any number or type of storage media including, but not limited to, high-end, high-throughput magnetic disks, one or more normal disks, optical disks jukeboxes of optical disks, tape silos, and/or collections of tapes or other storage devices that are store-off line. In general however, the various storage devices may be partitioned into two basic categories. The first category is local storage which contains information that is locally available to the computer system. The second category is remote storage which includes any type of storage device that contains information that is not locally available to a computer system. While the line between the two categories of devices may not be well defined, in general, local storage has a relatively quick access time and is used to store frequently accessed data, while remote storage has a much longer access time and is used to store data that is accessed less frequently. The capacity of remote storage is also typically an order of magnitude larger than the capacity of local storage.

A number of program modules may be stored on the hard disk, magnetic disk 129, optical disk 131, ROM 124 or RAM 125, including an operating system 135, one or more application programs 136, other program modules 137, and program data 138. Such application programs may include, but are not limited to, graphic modules or modeling modules for generating graphics and models for users display, graphical user interfaces, image processing modules, intelligent systems modules (such as neural networks), specialized image tracking modules, camera control modules, camera acquisition modules, GUI development systems or other. A user may enter commands and information into the computer 120 through input devices such as keyboard 140 and pointing device 142. Other input devices (not shown) may include a microphone, joy stick, game pad, satellite dish, scanner, or the like. These and other input devices are often connected to the processing unit 121 through a serial port interface 146 that couples directly to the system bus 123. It may also connect by other interfaces, such as parallel port, game port, firewire or a universal serial bus (USB). A monitor 147 or other type of display device is also connected to the system bus 123 via an interface, such as a video adapter 18. In addition to the monitor, computers often include other peripheral output devices (not shown), such as speakers and printers. Scanner peripheral devices (not shown) for reading imagery into the computer are often also included.

During use, the computer 120 may operate in a networked environment using logical connections to one or more other computing configurations, such as a remote computer 149. Remote computer 149 may be a personal computer, a server, a router, a network PC, a peer device or other common network node, and typically includes many or all of the elements described above relative to the computer 120, although only a memory storage device 150 having application programs 136 has been illustrated. The logical connections between the computer 120 and the remote computer 149 include a local area network (LAN) 151 and/or a wide area network (WAN) 152 that are presented here by way of example and not limitation. Such networking environments are commonplace in offices with enterprise-wide computer networks, intranets and the Internet, but may be adapted for use in a mobile or on-site manner at multiple and/or changing locations.

When used in a LAN networking environment, the computer 120 is connected to the local 'area network 151 through a network interface or adapter 153. When used in a WAN networking environment, the computer 120 typically includes a modem 154, Ti line, satellite or other means for establishing communications over the wide area network 152, such as the Internet. The modem 154, which may be internal or external, is connected to the system bus 123 via the serial port interface 146. In a networked environment, program modules depicted relative to the computer 120, or portions thereof, may be stored in the local or remote memory storage devices and may be linked to various processing devices for performing certain tasks. It will be appreciated that the network connections shown are exemplary and other means of establishing a communications link between the computers may be used.

Moreover, those skilled in the art will appreciate that the invention may be practiced with other computer system configurations, including hand-held devices, multi-processor systems, micro-processor-based or programmable consumer electronics, network PCs, minicomputers, computer clusters, main frame computers, and the like.

Finally, the foregoing description is presented for purposes of illustration and description of the various aspects of the invention. The descriptions are not intended, however, to be exhaustive or to limit the invention to the precise form disclosed. Accordingly, the embodiments described above were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A method for communicating information about a visitor visiting an online auction, comprising:
obtaining a code;
emplacing said code into an auction description of said online auction; and
upon said visitor visiting said online auction, providing said information about said visitor.

2. The method of claim 1, wherein said obtaining further includes obtaining said code from a website different from a website hosting said online auction.

3. The method of claim 1, wherein said providing further includes providing said information about said visitor at a website different from a website hosting said online auction.

4. The method of claim 1, further including upon said visitor visiting said online auction, recording and transmitting visitor environment variables.

5. The method of claim 1, wherein said providing said information about said visitor, further includes displaying visitor environment variables and search criteria.

6. A method for receiving information about a visitor visiting an online auction of a seller, comprising:
by said seller, obtaining a code;
by said seller, inserting said code into an auction description of said online auction; and
upon said visitor visiting said online auction, recording said information about said visitor; and
transmitting said information to said seller.

7. A method for providing information about a visitor visiting an online auction of a seller, comprising:
displaying an auction description of said online auction to be completed by said seller;
receiving a computer code from said seller in said auction description; and
upon said visitor visiting said online auction, displaying said information to said seller.

8. The method of claim 7, wherein said receiving further includes making said computer code available at an online auction venue website hosting said online auction.

9. A method for providing information about a visitor visiting an online auction of a seller, comprising:
inquiring whether said seller desires to receive said information about said visitor visiting said online auction; and
upon an affirmative response from said seller, making said information available to said seller.

10. The method of claim 9, further including providing a code to said seller for entry into an auction description of said online auction.

11. The method of claim 10, wherein said providing said code further includes emplacing said code into an auction description of said online auction.

12. The method of claim 11, wherein said emplacing occurs automatically upon said affirmative response from said seller.

13. The method of claim 9, wherein said inquiring further includes inquiring from one of a website hosting said online auction and a website different from a website hosting said online auction.

14. The method of claim 9, wherein said making said information available further includes making available a manner in which said visitor found said online auction.

15. The method of claim 9, wherein said making said information available further includes making available a search term of said visitor.

16. The method of claim 9, wherein said making said information available further includes making available whether a search term of said visitor was searched for in a title or in a title and description of said online auction.

17. A method for providing information about a visitor visiting an online auction of a seller, comprising:
obtaining an indication whether said seller desires to receive said information about said visitor visiting said online auction; and
making said information available to said seller.

18. The method of claim 17, wherein said making said information available further includes emplacing a scripting language code in an auction description of said online auction.

19. The method of claim 18, wherein said making said information available further includes, by said seller, accessing a server and loading a cgi script.

20. The method of claim 19, wherein said cgi script opens a logfile of said seller.

21. A scripting language data structure on a storage medium that becomes rendered on a page of a website for eventual emplacement in an auction description of an online auction, comprising the lines of code:
var referringpage=escape(document.referrer);
var maindomain=“http://www.domain.com/”;
var currentpage=location.href;
var pagetitle=document.title;
document.write(“<img src=\”“+maindomain+”cgi-bin/track.cgi?1=“+referringpage+”&a=“+currentpage+”&r=“+itemReserve+”&p=“+pagetitle+”\“height=x width=y>”);
wherein x and y are numbers indicative of a desired pixel size.

22. The data structure of claim 21, wherein the lines of code are written in JAVASCRIPT language.

23. The data structure of claim 21, wherein said website is different from a venue website hosting said online auction.

24. The data structure of claim 21, wherein during use the lines of code are cut or copied from said page and pasted, copied or inserted in said auction description hosted by a venue website.

25. In a computing environment, a method for providing information about a visitor visiting an online auction of a seller, comprising:
by said seller, visiting a first website;
by said seller, obtaining a scripting language code on a page of said first website;
by said seller, visiting a second website;
by said seller, emplacing said scripting language code in an auction description of said online auction, said online auction being a part of said second website;
by said visitor, searching said second website;
by said visitor, visiting said online auction;
thereafter, by said seller, visiting said first website; and
thereafter, by said seller, viewing information on how said visitor arrived at or visited said online auction.

26. A computing environment for displaying information about a visitor visiting an online auction of a seller, comprising:
a first server storing a scripting language data structure to-be-rendered to said seller upon said seller accessing a first website; and
a second server that enables display of an auction description of said online auction, said auction description able to receive said data structure.

27. The computing environment of claim 26, wherein said first and second server are the same server.

28. In a computing environment, a method for providing information about a visitor visiting an online auction of a seller, comprising:
recording information of a visitor of said online auction, said information including visitor environment variables and visitor search criteria;
transmitting said information to a server not associated with a venue of said online auction;
storing said information;
retrieving said information; and
presenting said information to said seller.

29. A computer readable medium having computer executable instructions for performing the steps:
generating a scripting language code for emplacement in an auction description of an online auction; and
emplacing said code in said auction description.

30. The computer readable medium of claim 29, further including causing a display of information of a visitor of said online auction to appear on a display.
